(19) United States
(12) Patent Application Publication
(10) Pub. No.: US 2011/0283741 A1
(43) Pub. Date: Nov. 24, 2011

(54) TUBE BENDING APPARATUS

(76) Inventors: Tjong-Ren Chang, Hsinchu City (TW); Wei-Yuan Tsou, Taoyuan County (TW); Chun-Chieh Huang, Hsinchu City (TW); Chin-Chia Chang, Keelung City (TW); Wen-Te Liu, Hsinchu County (TW)

(21) Appl. No.: 12/783,314

(22) Filed: May 19, 2010

(51) Int. Cl. C03B 23/04

(52) U.S. Cl. 65/292

(57) ABSTRACT

A tube bending apparatus for bending a straight lamp tube includes a horizontal heating chamber, a vertical heating chamber and a tube bending mold. The horizontal heating chamber includes a bending tube heating zone and two pre-heating zones. The bending tube heating zone has a working temperature higher than that of the two pre-heating zones. The vertical heating chamber communicates with the horizontal heating chamber and includes a mold heating zone. The mold heating zone has a working temperature higher than or equal to that of the bending tube heating zone. The tube bending mold is heated in the mold heating zone in a working temperature to bend the straight lamp tube held and heated in the horizontal heating chamber.

### FIELD OF THE INVENTION

The present invention relates to a tube bending apparatus and particularly to a tube bending apparatus to automatically bend lamp tubes.

### BACKGROUND OF THE INVENTION

Energy-saving lamps are more eco-friendly, consume less electric power and have higher lighting efficiency, thus are well accepted on the market and have gradually displaced the traditional halogen lamps. The commonly seen energy-saving lamps at present are helical light bulbs which are mostly formed by manually bending.

Refer to FIGS. 1A and 1B for a conventional technique of forming a helical lamp tube by bending a straight glass tube 1 through a tube bending mold. The process includes: first, heat the center of the straight glass tube 1 to a plastic condition; next, clamp two ends of the straight glass tube 1 manually and place the center of the straight glass tube 1 at the top portion of a tube bending mold 2 in a fixed manner; then activate the tube bending mold 2 to rotate, so that operator can roll the two ends of the straight glass tube 1 on the tube bending mold 2; after cooling, release the mold to finish fabrication of the helical lamp tube.

During the process of bending the straight glass tube 1 manually, a heating unit has to be employed to heat and deform the intended bending portion. Referring to FIG. 1B, two heaters 3 are provided at two sides of the tube bending mold 2 to heat respectively the lamp tube at one point so that the intended bending portion is softened in a plastic condition and becomes bendable to be closely in contact with the tube bending mold 2.

The aforesaid fabrication process still has problems as follow: First, the heaters 3 usually are blow torches and difficult to control flame temperature precisely; they also can heat merely a small section or one point at the bending portion, hence is only suitable for a straight glass tube which is not doped with fluorescent powder (i.e. without sealed openings) or non-vacuum straight tube to avoid shrinking or bursting of the glass tube caused by overheated temperature at one point; during bending the straight glass tube which is not doped with fluorescent powder, the two ends of the straight glass tube 1 have to be additionally injected by compressed air to provide air pressure to support the heated and softened portion and maintain it in a steady structure without shrinking the softened tube wall and causing uneven thickness; besides, the whole process is performed manually, hence fabrication cost is higher, the speed is slower and cannot produce in a great amount to meet requirements; the lamp tube also has to be moved and bent manually that heavily depend on people's experience and technique and could easily affect product quality. As a result, quality consistence of finished products is difficult to maintain, defective products are more likely being generated and material waste easily occurs.

In another aspect, on fabrication of a helical discharged fluorescent tube, extra processes have to be done for the glass tube which is not doped with fluorescent powder after bending, such as sealing electrodes, displacing gas, diffusing mercury, sealing, etc. Since the lamp tube is formed in the helical fashion, according to the aforesaid processes, impurity gases in the tube are difficult to be exhausted. Too much residual impurity gases will affect electron collision in the lamp tube and reduce lighting efficiency. Moreover, during the displacing gas and diffusing mercury processes, the impurity gases can be exhausted by increasing the temperature and baking. However, the bent helical lamp tube cannot withstand overheated temperature to avoid thermo-deformation. All these show that fabricating the helical lamp tube by manually bending still leaves a lot to be improved, and often results in lower lighting efficiency and inconsistent quality.

### SUMMARY OF THE INVENTION

Therefore, the primary object of the present invention is to solve the problem of slow production speed in the conventional manual lamp tube bending process by providing an automatic bending helical lamp tube apparatus that includes heating units at different sections to bend lamp tubes mechanically and easily. The present invention not only reduces fabrication time, but also increases fabrication speed.

Another object of the invention is to provide a tube bending apparatus adaptable to vacuum fluorescent tubes to improve lighting efficiency and enhance lamp tube quality.

To achieve the foregoing objects, the tube bending apparatus according to the invention comprises a horizontal heating chamber, a vertical heating chamber and a tube bending mold. The horizontal heating chamber includes a bending tube heating zone and two pre-heating zones. The bending tube heating zone is located between the two pre-heating zones and has a working temperature higher than that of the two pre-heating zones. The vertical heating chamber communicates with the bending tube heating zone of the horizontal heating chamber and includes a mold heating zone. The mold heating zone has a working temperature higher than or equal to that of the bending tube heating zone. The tube bending mold is located in the vertical heating chamber and movable up and down therein. The mold heating zone can heat the tube bending mold at a working temperature to bend a straight lamp tube held and heated in the horizontal heating chamber.

According to an embodiment of the invention, the tube bending apparatus further includes a lamp tube conveyance means to convey a straight lamp tube to the horizontal heating chamber to be heated to a preset temperature.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a partial schematic view of bending a helical lamp tube through a conventional tube bending mold;

FIG. 1B is a schematic view of bending a helical lamp tube through a conventional tube bending mold;

FIG. 2 is a schematic view of an embodiment of the tube bending apparatus of the invention; and

FIGS. 3A through 3E are schematic views of the processes of bending a tube through the tube bending apparatus of the invention.

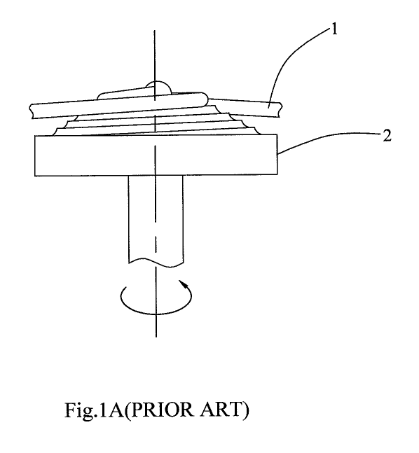

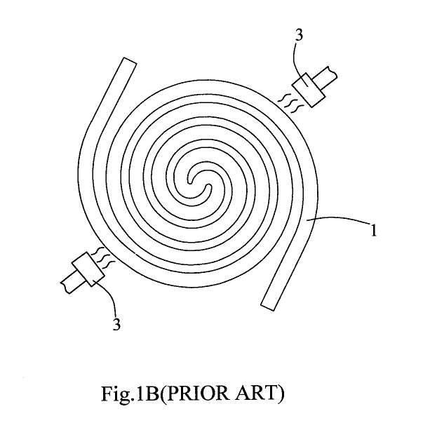

### DETAILED DESCRIPTION OF THE PREFERRED EMBODIMENTS

The present invention aims to provide a tube bending apparatus to automatically bend a straight glass tube to a desired bending shape. The shape can be any type depending on a tube bending mold chosen, such as helical, volute, circular, elliptical and the like without special restrictions. On the other hand, the tube bending apparatus of the invention also is adaptable for bending any straight fluorescent tube, such as cold cathode fluorescent lamps or hot cathode fluorescent lamps, either the glass tube is not doped with fluorescent powder or is a vacuum tube with two ends sealed, there is no restriction. The discussion below is based on an embodiment of bending a helical cold cathode fluorescent lamp as an example.

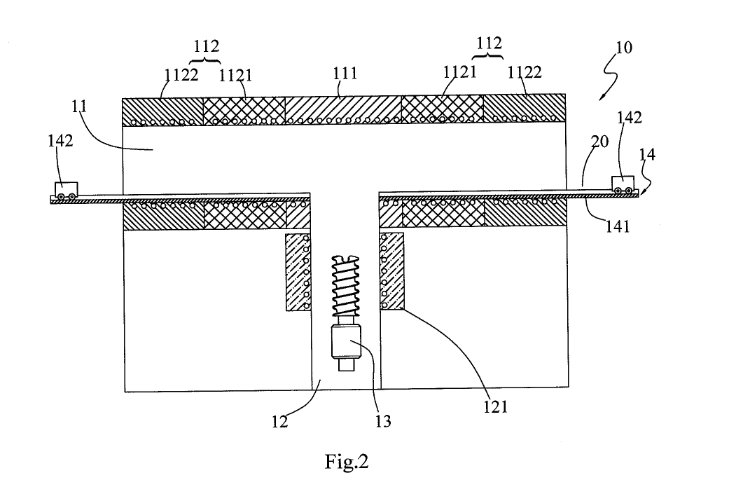

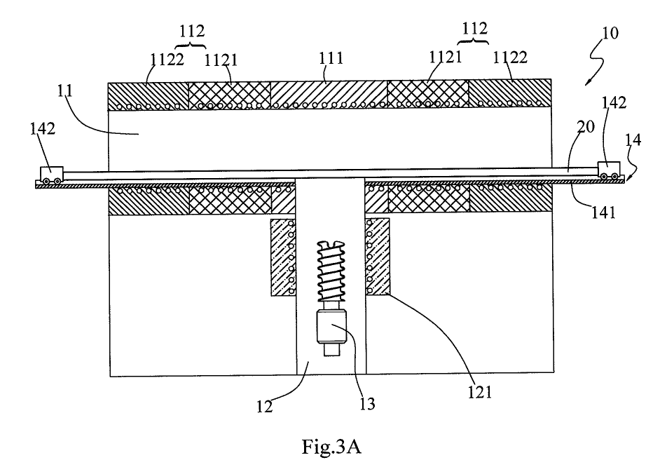

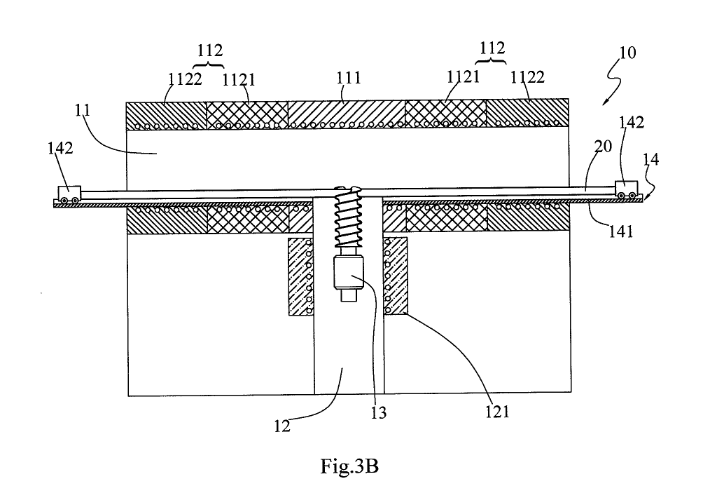

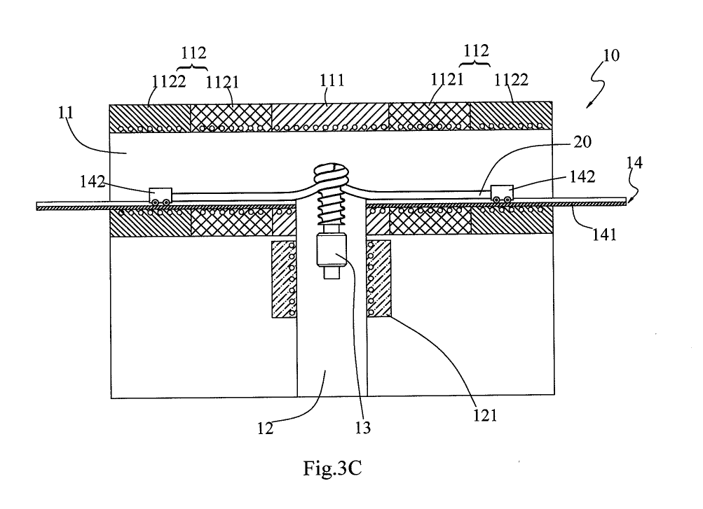

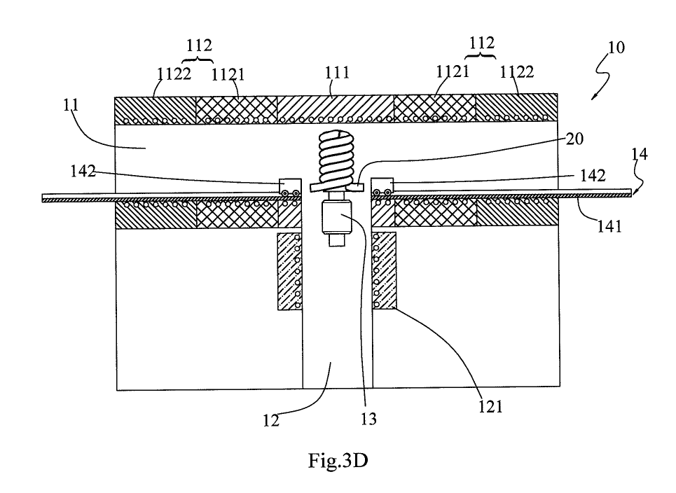

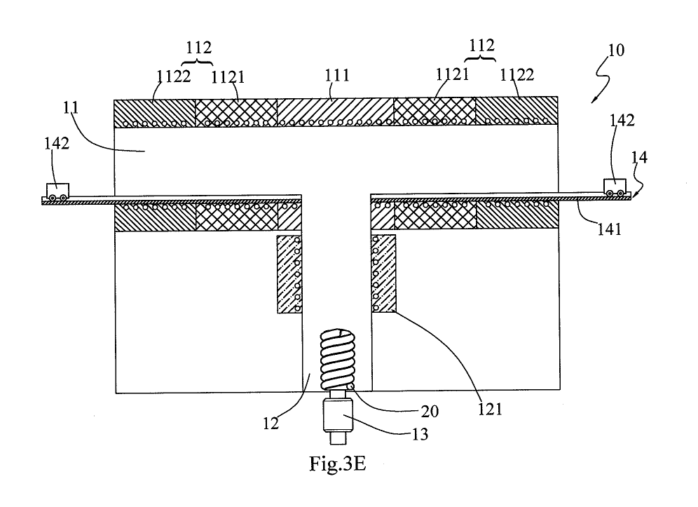

Please refer to FIG. 2, the present invention provides a tube bending apparatus 10 which comprises a horizontal heating chamber 11, a vertical heating chamber 12, a tube bending mold 13 and a lamp tube conveyance means 14. The vertical heating chamber 12 aims to heat the tube bending mold 13. The lamp tube conveyance means 14 aims to convey a straight lamp tube 20 (referring to FIG. 3A) to the horizontal heating chamber 11 to be heated to a preset temperature. Then the straight lamp tube 20 is bent through the tube bending mold 13. Finally, the mold is released to form a finished product. Details are elaborated as follow:

First, the lamp tube conveyance means 14 includes a plurality of guiding tracks 141 and a plurality of ancillary pushing elements 142 (two sets are shown in the drawings). The guiding tracks 141 are respectively located at two ends of the horizontal heating chamber 11. The ancillary pushing elements 142 are located on the guiding tracks 141 and slidable thereon. Hence the straight lamp tube 20 has two ends clamped by the ancillary pushing elements 142 and carried on the guiding tracks 141, and pushed by the ancillary pushing elements 142 into the horizontal heating chamber 11 to be positioned.

The horizontal heating chamber 11 aims to heat the straight lamp tube 20 positioned therein. The horizontal heating chamber 11 includes a bending tube heating zone 111 and two pre-heating zones 112. The bending tube heating zone 111 is located between the two pre-heating zones 112. Each pre-heating zone 112 includes, from the bending tube heating zone 111 towards an outer side in this order, a first pre-heating zone 1121 and a second pre-heating zone 1122. The bending tube heating zone 111 has a working temperature higher than that of the two pre-heating zones 112. The working temperature of the first pre-heating zone 1121 is higher than that of the second pre-heating zone 1122. Hence the straight lamp tube 20 can be heated gradually from two ends towards the middle portion. Thereby the portion at the bending tube heating zone 111 can be heated to a plastic condition and is bendable without shrinking or bursting, while the portion at the pre-heating zone 112 can be heated to a temperature to be softened without deforming.

The tube bending mold 13 is located in the vertical heating chamber 12 and movable up and down therein. The vertical heating chamber 12 communicates with the bending tube heating zone 111 of the horizontal heating chamber 11, and includes a mold heating zone 121 which has a working temperature higher than or equal to that of the bending tube heating zone 111 to heat the tube bending mold 13 to a desired working temperature to prevent a cold/hot effect when the tube bending mold 13 is in contact with the straight lamp tube 20 and avoid degradation of the straight lamp tube 20 or bad thermo effect and internal stress.

In the embodiment set forth above, the bending tube heating zone 111 and mold heating zone 121 respectively have a working temperature in the range of 500 to 800° C.; and the pre-heating zones 112 respectively have a working temperature in the range of 300 to 700° C. Exact working temperatures may vary depending on glass types, thickness, length or bending types of the straight lamp tube 20.

Refer to FIGS. 3A through 3E for the processes of automatic bending the straight lamp tube 20 to a helical lamp tube through the tube bending apparatus 10. First, place the straight lamp tube 20 to be bent on the two guiding tracks 141 with two ends thereof butted by the two ancillary pushing elements 142; next, control the two ancillary pushing elements 142 to move the straight lamp tube 20 into the horizontal heating chamber 11 at a preset position as shown in FIG. 3A; meanwhile, heat the tube bending mold 13 in the mold heating zone 121 to a desired working temperature while the straight lamp tube 20 is heated in the bending tube heating zone 111 and pre-heating zones 112 for a preset duration until each section reaching to a preset temperature.

After the straight lamp tube 20 is heated to the preset temperature, the tube bending mold 13 is moved upwards in the vertical heating chamber 12 with the top portion thereof latching the straight lamp tube 20 at the section of the bending tube heating zone 111 as shown in FIG. 3B; after stilling for a preset duration (such as 1 to 60 seconds), start to perform tube bending operation. Take fabricating a helical lamp tube as an example, the tube bending mold 13 can be rotated steadily at a preset speed to allow the straight lamp tube 20 to be rolled automatically on the tube bending mold 13 along the guiding tracks 141 to achieve automatic bending effect as shown in FIG. 3C. While the lamp tube is bent, the unheated portion is gradually moved to the pre-heating zones 112 to be heated and then moved to the bending tube heating zone 111 to be heated to a plastic condition. Considering the overall bending speed and heat transmission conditions, in the embodiment previously discussed, the bending tube heating zone 111 and pre-heating zones 112 may cover at least ⅔ of the length of the straight lamp tube 20 to be processed, i.e. the heating areas of the bending tube heating zone 111 and pre-heating zones 112 are greater than ⅔ of the length of the straight lamp tube 20.

Next, with the straight lamp tube 20 gradually rolled on the tube bending mold 13 and the two ends thereof gradually moved into the horizontal heating chamber 11, the ancillary pushing elements 142 push the two ends of the straight lamp tube 20 into the horizontal heating chamber 11 with mating the type and rotational speed of the tube bending mold 13 until the straight lamp tube 20 is fully rolled on the tube bending mold 13 as shown in FIG. 3D. Finally, the tube bending mold 13 and the helical lamp tube rolled thereon are lowered and withdrawn from the mold heating zone 121 to be cooled and released to form a finished product as shown in FIG. 3E.

It is to be noted that the bending tube heating zone 111, first pre-heating zone 1121, second pre-heating zone 1122 and mold heating zone 121 previously discussed are defined according to heating zones with different working temperatures in the horizontal heating chamber 11 and vertical heating chamber 12. In practice, there could be no definite boundary to the structure or appearance of the horizontal heating chamber 11 and vertical heating chamber 12. Moreover, the bending tube heating zone 111, first pre-heating zone 1121, second pre-heating zone 1122 and mold heating zone 121 are heated through electric heating coils which surround the horizontal heating chamber 11 and vertical heating chamber 12 to easily control temperature stability of the heating zones.

The tube bending apparatus 10 according to the invention provides different heating zones to maintain most portions of the straight lamp tube 20 to be bent at higher working temperatures so that the lamp tube can rapidly reach to the plastic condition to be bent and deformed. Moreover, by rotating the tube bending mold 13 and incorporating with the ancillary pushing elements 142, the lamp tube can be bent automatically. In addition, the internal temperature of the tube bending apparatus 10 can be controlled steadily, thus the apparatus is adaptable to bending of vacuum lamp tubes, such as bending a cold cathode fluorescent lamp which is already coated with fluorescent powder, changed gas, diffused mercury and sealed two ends to a helical profile to improve lighting efficiency.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A tube bending apparatus for bending a straight lamp tube, comprising:
a horizontal heating chamber which includes a bending tube heating zone and two pre-heating zones, the bending tube heating zone softening a portion of the straight lamp tube to a plastic condition, the two pre-heating zones preheating the straight lamp tube, the bending tube heating zone being located between the two pre-heating zones and has a working temperature higher than that of the two pre-heating zones;
a vertical heating chamber which communicates with the bending tube heating zone and includes a mold heating zone having another working temperature higher than or equal to that of the bending tube heating zone; and
a tube bending mold which is located in the vertical heating chamber and movable up and down in the vertical heating chamber;
wherein the tube bending mold is heated in the mold heating zone to bend the straight lamp tube held and heated in the horizontal heating chamber.

2. The tube bending apparatus of claim 1 further comprising a lamp tube conveyance means which includes a plurality of guiding tracks and a plurality of ancillary pushing elements; the guiding tracks being located in the horizontal heating chamber to carry the straight lamp tube; the ancillary pushing elements being located on the guiding tracks to move the straight lamp tube to slide on the guiding tracks.

3. The tube bending apparatus of claim 1, wherein the working temperature of the bending tube heating zone is in a range from 500° C. to 800° C.

4. The tube bending apparatus of claim 1, wherein the working temperature of the mold heating zone is in a range from 500° C. to 800° C.

5. The tube bending apparatus of claim 1, wherein the working temperature of the pre-heating zone of the horizontal heating chamber is in a range from 300° C. to 700° C.

6. The tube bending apparatus of claim 1, wherein the bending tube heating zone, the pre-heating zones and the mold heating zone are heated through a plurality of electric heating coils.

7. The tube bending apparatus of claim 1, wherein the bending tube heating zone and the pre-heating zones include heating areas greater than two-third of the length of the straight lamp tube.

8. The tube bending apparatus of claim 1, wherein the straight lamp tube is a cold cathode fluorescent lamp.
